(19) United States
(12) Patent Application Publication
(10) Pub. No.: US 2025/0025370 A1
(43) Pub. Date: Jan. 23, 2025

(54) ACOUSTIC SHOCK WAVE THERAPEUTIC METHODS TO TREAT NEUROLOGICAL CONDITIONS USING REFLEXOLOGY ZONES

(71) Applicant: John F. Warlick, Kennesaw, GA (US)

(72) Inventor: John F. Warlick, Kennesaw, GA (US)

(21) Appl. No.: 18/353,419

(22) Filed: Jul. 17, 2023

(51) Int. Cl. A61H 23/00; A61H 39/04

(52) U.S. Cl. CPC A61H 23/008; A61H 39/04; A61H 2201/1654; A61H 2205/067; A61H 2205/125

(57) ABSTRACT

The device of the present invention allows for a method of treating a patient exhibiting sensitivity of neurological tissue by treating brain tissue or treating a reflexology zone to reduce plaque and inflammation of the brain tissue using pressure pulses or shock waves. The treatment method has the steps of placing an applicator head of an acoustic shock wave or pressure pulse generator or source on or near brain tissue or reflexology zone; coupling the applicator head directly or indirectly to an exposed surface of the region being treated; and activating the generator or source to emit pressure pulses or acoustic shock waves to the brain tissue or reflexology zone to treat the brain tissue exhibiting a plaque buildup and inflammation to reduce the plaque and inflammation.

### FIELD OF THE INVENTION

The present invention relates to an improved treatment method of utilizing acoustic shock waves or pressure pulses to treat neurological conditions, brain disorders or diseases using reflexology zones.

### BACKGROUND OF THE INVENTION

In U.S. Pat. No. 7,470,240 B2, entitled “Pressure Pulse/Shock Wave Therapy Methods And An Apparatus For Conducting The Therapeutic Methods”, is disclosed a novel use of unfocused shock waves to stimulate a cellular substance. From this patent a family of treatment patents evolved. The list includes U.S. Pat. Nos. 7,841,995; 7,883,482; 7,905,845 all divisional applications; and U.S. Pat. No. 7,507,213 entitled “Pressure Pulse/Shock Wave Therapy Methods For Organs”; U.S. Pat. No. 7,544,171 B2 entitled “Methods for Promoting Nerve Regeneration and Neuronal Growth and Elongation”; U.S. Pat. No. 7,988,648 B2 entitled “Pancreas Regeneration Treatment For Diabetics Using Extracorporeal Acoustic shock waves or pressure pulses”; all teaching a new useful way to deliver acoustic shock waves or pressure pulses to achieve a healing response. Each of these patents are incorporated herein by reference in their entirety. In addition, U.S. Pat. Nos. 8,257,282 and 8,535,249 for the device to perform these methods by delivering low energy unfocused acoustic shock waves or pressure pulses to the cellular tissue being treated.

During this inventive research, the inventors disclosed the use of acoustic shock waves or pressure pulses could be beneficial as a disease preventative therapy of at risk patients.

While this large volume of research has been rewarded by the granting of numerous patents, much new work has been evolving as the understanding of the technology is being applied. It is in this latest work that some, heretofore, unknown improvements and refinements have been discovered that were hidden from and unappreciated by scientists in this field. In particular, the use of acoustic shock waves or pressure pulses to treat neurological conditions by treating reflexology zones related to the brain.

### SUMMARY OF THE INVENTION

The drug for Alzheimer's and any other plaque drugs in the future can be enhanced/improved with the application of low energy acoustic shock waves referred to as softwaves, these softwaves are emitted via targeted regions or zones in extremities called reflexology zones and directly treating the brain and or brain stem. Softwaves remove, reduce, cause to be absorbed or metabolized plaques. Softwaves prevent plaques from developing by reducing, preventing inflammation, inflammation causes plaques to develop. Softwaves prevent plaques, reduce plaques, destroy plaques, cause to be reabsorbed, and cause the immune system to identify and attack plaques. All of these dramatically improve the performance of any amyloid plaque targeting drug. Reflexology treatment reduces systemic and local inflammation. Also, softwaves or many other types of soundwaves allow drugs and other plaque fighting cells to cross the blood brain barrier more efficiently by targeting the base of the skull or brainstem.

A treatment method to reduce or eliminate a patient's symptoms caused by a neurological medical condition; the treatment has the step of: administering acoustic shock waves or pressure pulses directed to an area near a source of the pain, if any is exhibited, or to a reflexology zone to treat the neurological medical condition. The treatment further has the steps of: activating acoustic shock waves or pressure pulses of an acoustic shock wave or pressure pulse generator to emit acoustic shock waves or pressure pulses; subjecting the area at or near the reflexology zone to acoustic shock waves or pressure pulses stimulating the area near the reflexology zone; and wherein the emitted acoustic shock waves or pressure pulses are focused or unfocused acoustic shock waves or pressure pulses.

The reflexology zone can underlie the patient's skin in a region of a foot or hand or ear. The shock wave or pressure pulse generator is acoustically coupled to the patient's skin using a coupling gel or liquid. The reflexology zone to treat a neurological medical condition for an orthopedic structure in a region of the foot is located in an outer surface of each foot near or at a toe. The reflexology zone to treat a neurological medical condition for an orthopedic structure is a region of the hand at or near fingers and thumb. The stimulating of the area causes a release of nitric oxide, secretion of digestive enzymes, hormones and other fluids reduces inflammation and absorbs plaque. The stimulating of the area causes a release of growth factors including, but not limited to VEGF and causes new blood vessels to be created increasing vascularization.

The treatment method is repeated one or more times prior to or during the medical procedure or after the medical procedure, the medical procedure being an injection of medicine to treat the neurological tissue. The neurological medical condition is Alzheimer's disease, and the treatment reduces neurological inflammation and plaque.

The emitted acoustic shock waves or pressure pulses are low energy soft waves. The low energy soft waves have an energy density in the range of 0.01 mJ/mm² to 1.0 mJ/mm². The treatment method of claim 12, wherein the low energy soft waves have an energy density in the range of 0.04 mJ/mm² to 0.3 mJ/mm². Each subjected reflexology zone receives between 100 and 2000 acoustic shock waves or pressure pulses per therapy session.

The emitted acoustic shock waves or pressure pulses are spherical, radial, convergent, divergent, planar, near planar, focused or unfocused from a source with or without a lens that is one of electrohydraulic, electromagnetic, piezoelectric, ballistic or water jets configured to produce an acoustic shock wave and wherein the acoustic shock waves or pressure pulses are administered invasively or noninvasively. The number of repeated treatments occur on a schedule over a period of three or more weeks, and treatments can be repeated over time as a pain prevention protocol over longer durations of time between repeated treatments. The neurological medical condition is one of Alzheimer's Disease, Amyotrophic Lateral Sclerosis (ALS), Ataxia, Epilepsy and Seizures, headache, Hydrocephalus, Meningitis, Parkinson's Disease, Stroke, Cluster Headaches, Tension Headaches, Migraine Headaches, Encephalitis.

The emitted acoustic shock waves or pressure pulses have an energy density in the range of 0.01 mJ/mm² to 50 mJ/mm².

A treatment method to reduce or eliminate a patient's symptoms caused by a neurological medical condition has the step of: administering acoustic shock waves or pressure pulses directed to an area of the brain and brain stem near a source of the neurological medical condition, and to a reflexology zone to treat the neurological medical condition.

### Definitions

“Alzheimer's” disease is a brain disorder that gets worse over time. It's characterized by changes in the brain that lead to deposits of certain proteins. Alzheimer's disease causes the brain to shrink and brain cells to eventually die. Two proteins believed to cause Alzheimer's disease are: Beta-amyloid which is a fragment of a larger protein. When these fragments clump together, they appear to have a toxic effect on neurons and to disrupt communication between brain cells. These clumps form larger deposits called amyloid plaques, which also include other cellular debris; and Tau proteins which are involved in a brain cell's internal support and transport system to carry nutrients and other essential materials. In Alzheimer's disease, tau proteins change shape and organize into structures called neurofibrillary tangles. The tangles disrupt the transport system and cause damage to cells.

A “curved emitter” is an emitter having a curved reflecting (or focusing) or emitting surface and includes, but is not limited to, emitters having ellipsoidal, parabolic, quasi parabolic (general paraboloid) or spherical reflector/reflecting or emitting elements. Curved emitters having a curved reflecting or focusing element generally produce waves having focused wave fronts, while curved emitters having a curved emitting surfaces generally produce wave having divergent wave fronts.

“Dementia” is a term used to describe a group of symptoms affecting memory, thinking and social abilities. In people who have dementia, the symptoms interfere with their daily lives. Dementia isn't one specific disease. Several diseases can cause dementia. Dementia generally involves memory loss. It's often one of the early symptoms of the condition. But having memory loss alone doesn't mean you have dementia. Memory loss can have different causes. Alzheimer's disease is the most common cause of dementia in older adults, but there are other causes of dementia. Depending on the cause, some dementia symptoms might be reversible.

“Divergent waves” in the context of the present invention are all waves which are not focused and are not plane or nearly plane. Divergent waves also include waves which only seem to have a focus or source from which the waves are transmitted. The wave fronts of divergent waves have divergent characteristics. Divergent waves can be created in many different ways, for example: A focused wave will become divergent once it has passed through the focal point. Spherical waves are also included in this definition of divergent waves and have wave fronts with divergent characteristics.

“Extracorporeal” means occurring or based outside the living body.

A “generalized paraboloid” according to the present invention is also a three-dimensional bowl. In two dimensions (in Cartesian coordinates, x and y) the formula yn=2px [with n being≠2, but being greater than about 1.2 and smaller than 2, or greater than 2 but smaller than about 2.8]. In a generalized paraboloid, the characteristics of the wave fronts created by electrodes located within the generalized paraboloid may be corrected by the selection of (p (−z,+z)), with z being a measure for the burn down of an electrode, and n, so that phenomena including, but not limited to, burn down of the tip of an electrode (−z,+z) and/or disturbances caused by diffraction at the aperture of the paraboloid are compensated for.

“Neurological disorders” are disorders that affect the brain, spinal cord, and nerves. Such disorders can occur as a result of structural, chemical, or electrical abnormalities within the nervous system. Neurological disorders are conditions that affect the central and peripheral nervous systems. Together, these systems include the brain, the spinal cord, and the nerves that extend out of these areas and into the rest of the body. Some common types of neurological disorders include headache, epilepsy, stroke, Alzheimer's disease, and Parkinson's Disease. These diseases affect different aspects of the nervous system and have their own associated causes, symptoms, and treatments.

A “paraboloid” according to the present invention is a three-dimensional reflecting bowl. In two dimensions (in Cartesian coordinates, x and y) the formula y2=2px, wherein p/2 is the distance of the focal point of the paraboloid from its apex, defines the paraboloid. Rotation of the two-dimensional figure defined by this formula around its longitudinal axis generates a de facto paraboloid.

“Plane waves” are sometimes also called flat or even waves. Their wave fronts have plane characteristics (also called even or parallel characteristics). The amplitude in a wave front is constant and the “curvature” is flat (that is why these waves are sometimes called flat waves). Plane waves do not have a focus to which their fronts move (focused) or from which the fronts are emitted (divergent). “Nearly plane waves” also do not have a focus to which their fronts move (focused) or from which the fronts are emitted (divergent). The amplitude of their wave fronts (having “nearly plane” characteristics) is approximating the constancy of plain waves. “Nearly plane” waves can be emitted by generators having pressure pulse/shock wave generating elements with flat emitters or curved emitters. Curved emitters may comprise a generalized paraboloid that allows waves having nearly plane characteristics to be emitted.

A “pressure pulse” according to the present invention is an acoustic pulse which includes several cycles of positive and negative pressure. The amplitude of the positive part of such a cycle should be above about 0.1 MPa and its time duration is from below a microsecond to about a second. Rise times of the positive part of the first pressure cycle may be in the range of nanoseconds (ns) up to some milliseconds (ms). Very fast pressure pulses are called shock waves. Shock waves used in medical applications do have amplitudes above 0.1 MPa and rise times of the amplitude can be below 1000 ns, preferably at or below 100 ns. The duration of a shock wave is typically below 1-3 microseconds (μs) for the positive part of a cycle and typically above some microseconds for the negative part of a cycle.

“Reflexology zone” as used herein means an area or pressure point on the feet or hands that are access pathways to every organ, gland, muscle, etc. These pathways between pressure points and other parts of the body are thought to be connected via the nervous system and that a neurological relationship exists between the skin and the internal organs, and that the whole nervous system adjusts to a stimulus. According to reflexology theory, application of pressure to feet, hands, or ears sends a calming message from the peripheral nerves in these extremities to the central nervous system, which in turn signals the body to adjust the tension level. This enhances overall relaxation, removes stress, brings internal organs and their systems into a state of optimum functioning, and increases blood supply which brings additional oxygen and nutrients to cells and enhances waste removal. It positively affects the circulatory, respiratory, endocrine, immune, and neuropeptide systems in the body.

“Shock Wave”: As used herein is defined by Camilo Perez, Hong Chen, and Thomas J. Matula; Center for Industrial and Medical Ultrasound, Applied Physics Laboratory, University of Washington, 1013 NE 40th Street, Seattle, Washington 98105; Maria Karzova and Vera A. Khokhlovab; Department of Acoustics, Faculty of Physics, Moscow State University, Moscow 119991, Russia; (Received 9 Oct. 2012; revised 16 Apr. 2013; accepted 1 May 2013) in their publication, “Acoustic field characterization of the Duolith: Measurements and modeling of a clinical shock wave therapy device”; incorporated by reference herein in its entirety.

Waves/wave fronts described as being “focused” or “having focusing characteristics” means in the context of the present invention that the respective waves or wave fronts are traveling and increase their amplitude in direction of the focal point. Per definition the energy of the wave will be at a maximum in the focal point or, if there is a focal shift in this point, the energy is at a maximum near the geometrical focal point. Both the maximum energy and the maximal pressure amplitude may be used to define the focal point.

### BRIEF DESCRIPTION OF THE DRAWINGS

The invention will be described by way of example and with reference to the accompanying drawings in which:

FIG. 1 is a simplified depiction of a pressure pulse/shock wave (PP/SW) generator with focusing wave characteristics.

FIG. 2 is a simplified depiction of a pressure pulse/shock wave generator with plane wave characteristics.

FIG. 3 is a simplified depiction of a pressure pulse/shock wave generator with divergent wave characteristics.

FIG. 4 is a simplified depiction of a pressure pulse/shock wave generator connected to a control/power supply unit.

FIG. 5 is a graph showing an exemplary ultrasound wave pattern.

FIG. 6 is a graph of an exemplary acoustic shock wave pattern.

FIG. 7 shows a patient being treated extracorporeally with shock waves being transmitted to the base of the skull or brain stem.

FIG. 8 shows the shock wave generator device directed at a reflexology zone on a foot of a patient.

FIG. 9 shows the shock wave generator device directed at a reflexology zone on a hand of a patient.

FIG. 10 shows a schematic view showing general reflexology locations of the foot in the human body.

FIG. 11 shows a schematic view showing general reflexology locations of the hand in the human body.

### DETAILED DESCRIPTION OF THE INVENTION

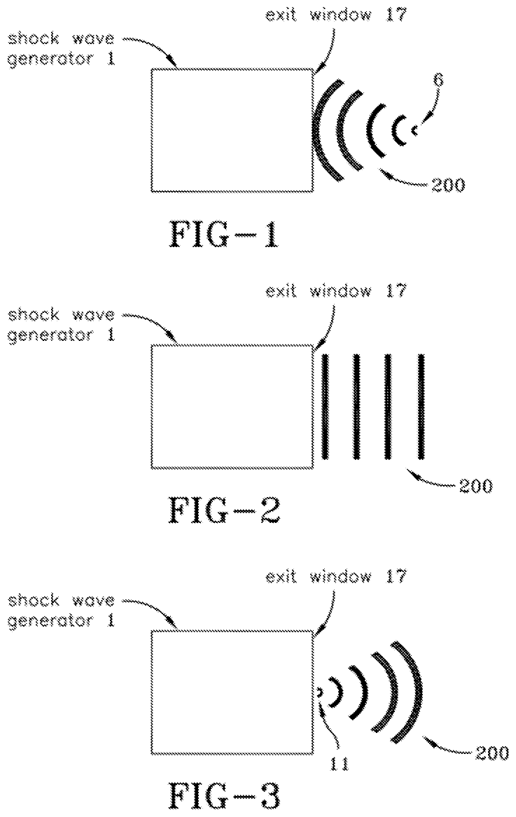

With reference to FIGS. 1-3, a variety of schematic views of acoustic shock waves or pressure pulses are described. The following description of the proper amplitude and pressure pulse intensities of the shock waves are provided along with a description of how the shock waves actually function. For the purpose of describing, the shock waves were used as exemplary and are intended to include all of the wave patterns discussed in the figures as possible treatment patterns for treating neurological tissue.

FIG. 1 is a simplified depiction of a pressure pulse/shock wave (PP/SW) generator, such as a shock wave head, showing focusing characteristics of transmitted acoustic pressure pulses. Numeral 1 indicates the position of a generalized pressure pulse generator, which generates the pressure pulse and, via a focusing element, focuses it outside the housing to treat diseases. The affected tissue or organ is generally located in or near the focal point which is located in or near position 6. At position 17 a water cushion or any other kind of exit window for the acoustical energy is located.

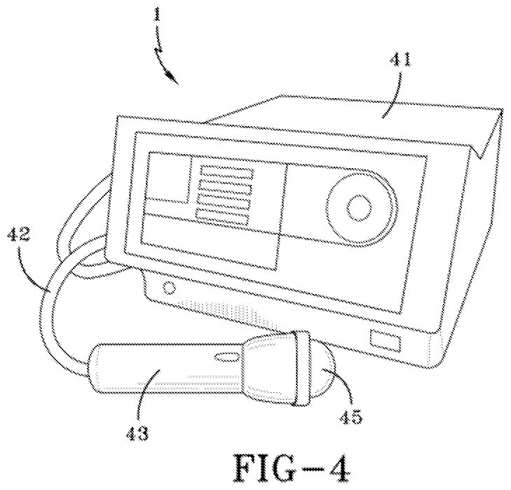

FIG. 2 is a simplified depiction of a pressure pulse/shock wave generator, such as a shock wave head, with plane wave characteristics. Numeral 1 indicates the position of a pressure pulse generator according to the present invention, which generates a pressure pulse which is leaving the housing at the position 17, which may be a water cushion or any other kind of exit window. Somewhat even, also referred to herein as “disturbed”, wave characteristics can be generated, in case a paraboloid is used as a reflecting element, with a point source (e.g. electrode) that is located in the focal point of the paraboloid. The waves will be transmitted into the patient's body via a coupling media such as, e.g., ultrasound gel or oil and their amplitudes will be attenuated with increasing distance from the exit window 17.

FIG. 3 is a simplified depiction of a pressure pulse shock wave generator (shock wave head) with divergent wave characteristics. The divergent wave fronts may be leaving the exit window 17 at point 11 where the amplitude of the wave front is very high. This point 17 could be regarded as the source point for the pressure pulses. In FIG. 3, the pressure pulse source may be a point source, that is, the pressure pulse may be generated by an electrical discharge of an electrode under water between electrode tips. However, the pressure pulse may also be generated, for example, by an explosion, referred to as a ballistic pressure pulse. The divergent characteristics of the wave front may be a consequence of the mechanical setup.

With reference to FIG. 4, an exemplary acoustic shock wave apparatus 1 is illustrated. The shock wave apparatus 1 has a generator 41 connected by a flexible hose with fluid conduits extending from the shock wave generator 41 to an applicator 43 which transmits the acoustic waves when coupled to the skin by using a fluid or acoustic gel. The applicator 43 as illustrated has a body that enables a technician to hold the applicator 43 and as illustrated this applicator is an electrohydraulic that is filled with fluid to facilitate the transmission of the shock waves. The fluid expands a flexible membrane in such a fashion that the membrane extends outwardly in a balloon shape fashion as illustrated in FIG. 4. As shown, this type of applicator 43 has a hydraulic spark generator using either focused or unfocused shock waves, preferably in a low energy level, less than the range of 0.01 mJ/mm² to 0.3 mJ/mm². The flexible hose 42 is connected to a fluid supply that fills the applicator 43 and expands the flexible membrane when filled. Alternatively, a ballistic, piezoelectric or spherical acoustic shock wave device can be used to generate the desired waves.

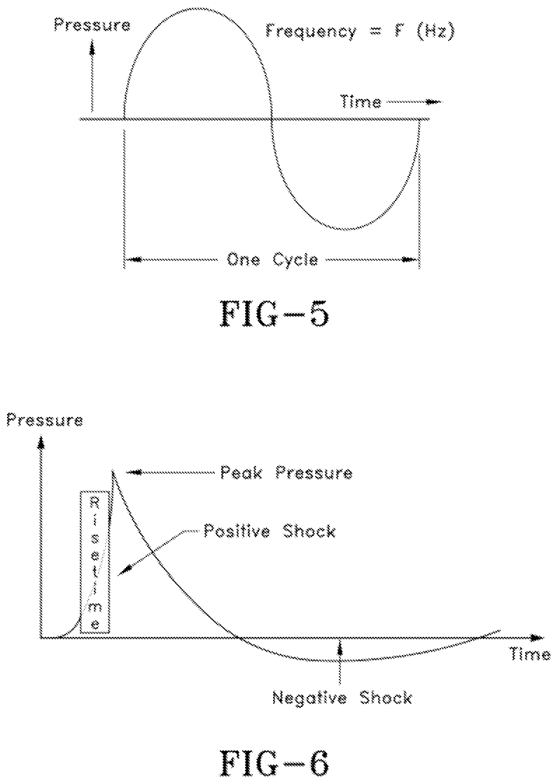

The ultrasonic wave pattern shown in FIG. 5 is contrasted to an asymmetric acoustic wave pattern which is illustrated in FIG. 6. As shown, ultrasound waves are symmetrical having the positive rise time equal to the negative in a sinusoidal wave form. These ultrasound waves generate heat in the tissue and are accordingly believed not suitable for use on organs or sensitive tissue.

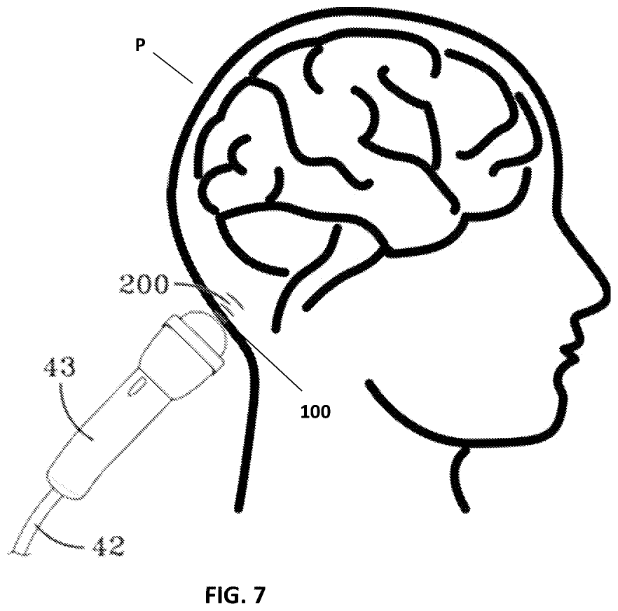

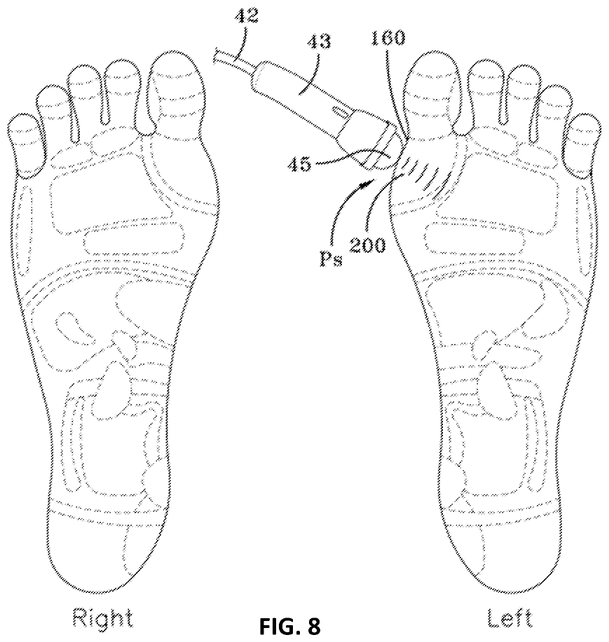

FIG. 7 is a depiction of an acoustic shock wave treatment to a region of the base of the skull or brain stem 100 of a patient P to reduce plaque or swelling or inflammation. The acoustic shock waves 200 are transmitted into the region 100 as shown.

FIG. 8 is a perspective view of a foot P_{F} of a patient P whose reflexology zone or target 160 for the brain tissue is being treated. A shock wave applicator head 43 is brought into contact with the skin Ps preferably an acoustic gel is used to enhance the transmission of the shock waves 200 through the skin Ps. The shock wave applicator head 43 can be handheld and manipulated across the skin Ps to drive the shock waves 200 in the direction the shock wave head 43 is pointed to activate a stimulating response through the reflexology zone 160.

As illustrated, the device shown is an electrohydraulic acoustic shock wave generator, however, other devices that generate acoustic shock waves can be used. Ultrasonic devices may be considered, but there is no data to support a sinusoidal wave form would work and therefore not considered as effective as the asymmetric wave generators. The acoustic shock waves activate a cellular response within the reflexology treatment site. This response or stimulation causes an increase of nitric oxide and a release of a variety of growth factors such as VEGF. As shown, the flexible membrane is protruding outward and the applicator 43 has been filled with fluid, the transmission or emission of acoustic shock waves 200 is directed towards the reflexology zone 160. In order to accomplish a good transmission, it is important the flexible membrane be pressed against the patient's P skin Ps and as indicated coupling gels may be used. The zone 160, as illustrated, is the reflexology zone for the pancreas which is a region of the foot P_{F} located in a middle of an inside arch of each foot. By transmitting the shock waves 200 to the zone 160, is it believed that a modulation of the secretions from the pancreas can be made. This modulation or adjustment is achieved by transmitting the acoustic waves 200 at low energy directly onto the zone 160. For the brain, the reflexology zones are at or near the toes.

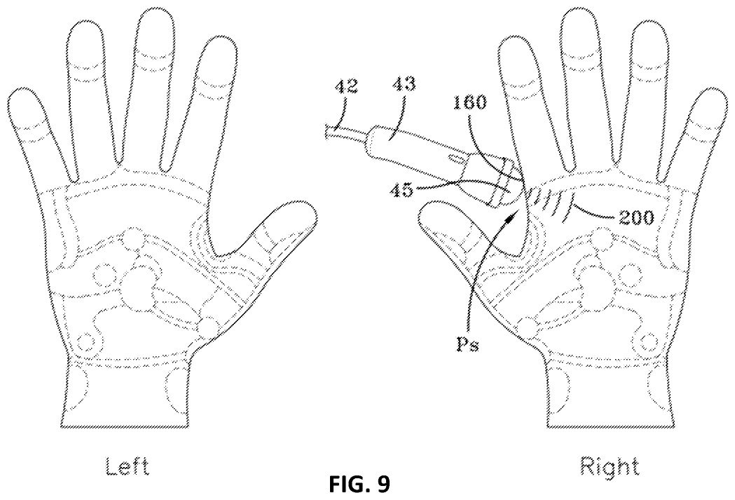

With reference to FIG. 9, a view of a hand P_{H} of a patient whose reflexology zone 160 is being treated with acoustic shock waves 200 is illustrated. In this illustration, it is important to note that the applicator 43 presses against the skin Ps of the hand in the reflexology zone 160 for the brain which is a region of the hand P_{H} at the tips of the fingers and thumb.

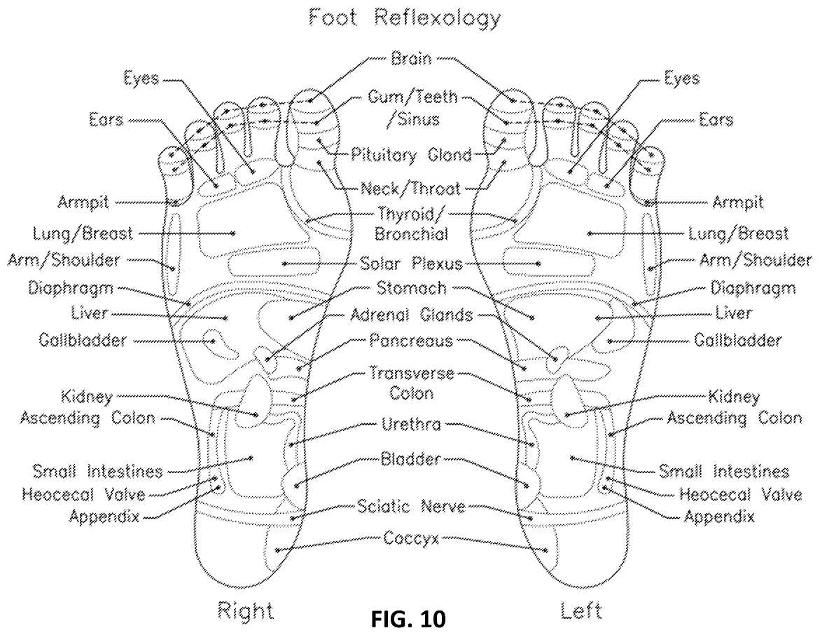

With reference to FIG. 10, a reflexology foot chart is shown detailing the various zones that correspond to organs, glands etc. of the body.

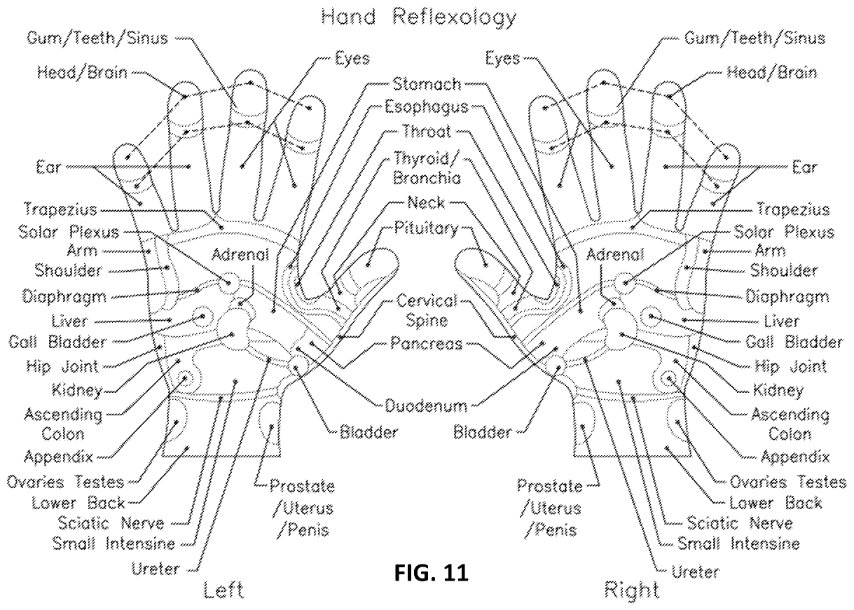

With reference to FIG. 11, a reflexology hand chart is shown detailing the various zones that correspond to organs, glands etc. of the body.

It is believed that modulation and beneficial adjustment can be achieved at reflexology zones for stimulating, modulating or adjusting reflexology zones for glands or organs such as the liver, kidney or any of those indicated in FIG. 11 for the foot zones and FIG. 12 for the hand zones will create a systemic anti-aging response. It is further believed that the hybrid Eastern medical acupuncture treatments or massages historically used are far less effective and less reliable than the results achieved by the deeper tissue penetrating transmission that are achieved by acoustic shock wave therapy applied to these reflexology zones.

This apparatus, in certain embodiments, may be adjusted/modified/or the complete shock wave head or part of it may be exchanged so that the desired and/or optimal acoustic profile such as one having wave fronts with focused, planar, nearly plane, convergent or divergent characteristics can be chosen.

This apparatus may, in certain embodiments, be adjusted/modified/or the complete shock wave head or part of it may be exchanged so that the desired and/or optimal acoustic profile such as one having wave fronts with focused, planar, nearly plane, convergent or divergent characteristics can be chosen.

A change of the wave front characteristics may, for example, be achieved by changing the distance of the exit acoustic window relative to the reflector, by changing the reflector geometry, by introducing certain lenses or by removing elements such as lenses that modify the waves produced by a pressure pulse/shock wave generating element. Exemplary pressure pulse/shock wave sources that can, for example, be exchanged for each other to allow an apparatus to generate waves having different wave front characteristics are described in detail below.

In certain embodiments, the change of the distance of the exit acoustic window can be accomplished by a sliding movement. However, in other embodiments of the present invention, in particular, if mechanical complex arrangements, the movement can be an exchange of mechanical elements.

In one embodiment, mechanical elements that are exchanged to achieve a change in wave front characteristics include the primary pressure pulse generating element, the focusing element, the reflecting element, the housing and the membrane. In another embodiment, the mechanical elements further include a closed fluid volume within the housing in which the pressure pulse is formed and transmitted through the exit window.

In one embodiment, the apparatus of the present invention is used in combination therapy. Here, the characteristics of waves emitted by the apparatus are switched from, for example, focused to divergent or from divergent with lower energy density to divergent with higher energy density. Thus, effects of a pressure pulse treatment can be optimized by using waves having different characteristics and/or energy densities, respectively.

While the above described universal toolbox of the present invention provides versatility, the person skilled in the art will appreciate that apparatuses that only produce waves having, for example, nearly plane characteristics, are less mechanically demanding and fulfill the requirements of many users.

As the person skilled in the art will also appreciate that embodiments shown in the drawings are independent of the generation principle and thus are valid for not only electro-hydraulic shock wave generation but also for, but not limited to, PP/SW generation based on electromagnetic, piezoceramic and ballistic principles. The pressure pulse generators may, in certain embodiments, be equipped with a water cushion that houses water which defines the path of pressure pulse waves that is, through which those waves are transmitted. In a preferred embodiment, a patient is coupled via ultrasound gel or oil to the acoustic exit window 17, which can, for example, be an acoustic transparent membrane, a water cushion, a plastic plate or a metal plate.

These shock wave energy transmissions are effective in stimulating a cellular response and can be accomplished without creating the cavitation bubbles in the tissue of the target site when employed in other than site targeted high energy focused transmissions. This effectively insures the tissue does not have to experience the sensation of hemorrhaging so common in the higher energy focused wave forms having a focal point at or within the targeted treatment site. Bleeding internally causes an increase in fluid pressure which can lead to increased damage. This can be completely avoided in this treatment protocol.

The fact that some if not all of the dosage can be at a low energy the common problem of localized hemorrhaging is reduced making it more practical to administer multiple dosages of waves from various orientations near the brain or brain stem to further optimize the treatment and cellular stimulation of the target site. Heretofore focused high energy multiple treatments induced pain and discomfort to the patient. The use of low energy focused or unfocused waves at the target site enables multiple sequential treatments.

The present method may need precise site location and can be used in combination with such known devices as ultrasound, cat-scan or x-ray imaging if needed. The physician's general understanding of the anatomy of the patient may be sufficient to locate the target area to be treated. This is particularly true when the device is visually within the surgeon's line of sight, and this permits the lens or cover of the emitting shock wave source to impinge on the affected tissue directly through a transmission enhancing gel, water or fluid medium during the pressure pulse or shock wave treatment. The treated area can withstand a far greater number of shock waves based on the selected energy level being emitted. For example, at very low energy levels the stimulation exposure can be provided over prolonged periods of as much as 20 minutes if so desired. At higher energy levels the treatment duration can be shortened to less than a minute, less than a second if so desired. The limiting factor in the selected treatment dosage is avoidance or minimization of surrounding cell hemorrhaging and other kinds of damage to the surrounding cells or tissue while still providing a stimulating stem cell activation or a cellular release or activation of proteins such as VEGF and other growth factors while simultaneously germicidally attacking the degenerative neural tissue or plaque buildup at the target site of the neurological tissue.

Due to the wide range of beneficial treatments available it is believed preferable that the optimal use of one or more wave generators or sources should be selected on the basis of the specific application. A key advantage of the present inventive methodology is that it is complimentary to conventional medical procedures. In the case of any operative surgical procedure the surgical area of the patient can be bombarded with these energy waves to stimulate cellular release of healing agents and growth factors. This will dramatically reduce the healing process time. Most preferably such patients may be provided more than one such treatment with an intervening dwell time for cellular relaxation prior to secondary and tertiary post operative treatments.

The underlying principle of these pressure pulse or shock wave therapy methods is to enrich the treatment area directly and to stimulate the body's own natural healing capability. This is accomplished by deploying shock waves to stimulate strong cells in the surrounding tissue to activate a variety of responses. The acoustic shock waves transmit or trigger what appears to be a cellular communication throughout the entire anatomical structure, this activates a generalized cellular response at the treatment site, in particular, but more interestingly a systemic response in areas more removed from the wave form pattern. This is believed to be one of the reasons molecular stimulation can be conducted at threshold energies heretofore believed to be well below those commonly accepted as required. Accordingly, not only can the energy intensity be reduced in some cases, but also the number of applied shock wave impulses can be lowered from several thousand to as few as one or more pulses and still yield a beneficial stimulating response. The key is to provide at least a sufficient amount of energy to activate healing reactions.

The use of shock waves as described above appears to involve factors such as thermal heating, light emission, electromagnetic field exposure, chemical releases in the cells as well as a microbiological response within the cells.

The unfocused shock waves can be of a divergent wave pattern, planar or near planar pattern preferably convergent diffused or far-sighted wave pattern, of a low peak pressure amplitude and density. Typically, the energy density values range as low as 0.000001 mJ/mm² and having a high end energy density of below 1.0 mJ/mm², preferably 0.20 mJ/mm² or less. The peak pressure amplitude of the positive part of the cycle should be above 1.0 and its duration is below 1-3 microseconds.

The treatment depth can vary from the surface to the full depth of the treated organ. The treatment site can be defined by a much larger treatment area than the 0.10-3.0 cm² commonly produced by focused waves. The above methodology is particularly well suited for surface as well as sub-surface soft tissue organ treatments like the brain.

While the above listed indications cited above are not exhaustive nor intended to be limiting, it is exemplary of the wide range of beneficial uses of high energy focused or low energy and amplitude unfocused divergent, planar or nearly planar shock waves, convergent shock waves, diffused shock waves or a combination of shock wave types in the treatment of humans and other mammals.

The biological model motivated the design of sources with low pressure amplitudes and energy densities. First: spherical waves generated between two tips of an electrode; and second: nearly even waves generated by generalized parabolic reflectors. Third: divergent shock front characteristics are generated by an ellipsoid behind f2. Unfocused sources are preferably designed for extended two dimensional areas/volumes like skin. The unfocused sources can provide a divergent wave pattern a planar or a nearly planar wave pattern and can be used in isolation or in combination with focused wave patterns yielding to an improved therapeutic treatment capability that is non-invasive with few if any disadvantageous contraindications. Alternatively, a focused wave emitting treatment may be used wherein the focal point extends preferably beyond the target treatment site, potentially external to the patient. This results in the reduction of or elimination of a localized intensity zone with associated noticeable pain effect while providing a wide or enlarged treatment volume at a variety of depths more closely associated with high energy focused wave treatment. The utilization of a diffuser type lens or a shifted far-sighted focal point for the ellipsoidal reflector enables the spreading of the wave energy to effectively create a convergent but off target focal point. This insures less tissue trauma while insuring cellular stimulation to enhance the healing process and control the migration or spreading of the infection within the host.

The method of treatment for brain tissue in a diagnosed patient is disclosed. The method has the steps of activating an acoustic shock wave generator or source to emit acoustic shock waves; and subjecting the brain tissue of the patient to the acoustic shock waves stimulating said brain tissue, wherein the brain tissue is positioned within a path of the emitted shock waves. The emitted shock waves are either convergent, divergent, planar or near planar. Alternatively, the emitted shock waves can be convergent having one or more geometric focal volumes or points at a distance of at least X from the generator or source, the method further comprising positioning the organ at a distance at or less than the distance X from the source.

It will be appreciated that the apparatuses and processes of the present invention can have a variety of embodiments, only a few of which are disclosed herein. It will be apparent to the artisan that other embodiments exist and do not depart from the spirit of the invention. Thus, the described embodiments are illustrative and should not be construed as restrictive.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A treatment method to reduce or eliminate a patient's symptoms caused by a neurological medical condition; the treatment comprises the step of:
administering acoustic shock waves or pressure pulses directed to an area near a source of the pain, if any is exhibited, or to a reflexology zone to treat the neurological medical condition.

2. The treatment method of claim 1, further comprises the steps of:
activating acoustic shock waves or pressure pulses of an acoustic shock wave or pressure pulse generator to emit acoustic shock waves or pressure pulses;
subjecting the area at or near the reflexology zone to acoustic shock waves or pressure pulses stimulating the area near the reflexology zone; and
wherein the emitted acoustic shock waves or pressure pulses are focused or unfocused acoustic shock waves or pressure pulses.

3. The treatment method of claim 1, wherein the reflexology zone underlies the patient's skin in a region of a foot or hand or ear.

4. The treatment method of claim 3, wherein the shock wave or pressure pulse generator is acoustically coupled to the patient's skin using a coupling gel or liquid.

5. The treatment method of claim 3, wherein the reflexology zone to treat a neurological medical condition for an orthopedic structure in a region of the foot is located in an outer surface of each foot near or at a toe.

6. The treatment method of claim 3, wherein the reflexology zone to treat a neurological medical condition for an orthopedic structure is a region of the hand at or near fingers and thumb.

7. The treatment method of claim 1, wherein the stimulating of the area causes a release of nitric oxide, secretion of digestive enzymes, hormones and other fluids reduces inflammation and absorbs plaque.

8. The treatment method of claim 7, wherein the stimulating of the area causes a release of growth factors including, but not limited to VEGF.

9. The treatment method of claim 8, wherein the stimulating of the area causes new blood vessels to be created increasing vascularization.

10. The treatment method of claim 2, is repeated one or more times prior to or during the medical procedure or after the medical procedure.

11. The treatment method of claim 2, wherein the emitted acoustic shock waves or pressure pulses are low energy soft waves.

12. The treatment method of claim 11, wherein the low energy soft waves have an energy density in the range of 0.01 mJ/mm² to 1.0 mJ/mm².

13. The treatment method of claim 12, wherein the low energy soft waves have an energy density in the range of 0.04 mJ/mm² to 0.3 mJ/mm².

14. The treatment method of claim 2, wherein each subjected reflexology zone receives between 100 and 2000 acoustic shock waves or pressure pulses per therapy session.

15. The treatment method of claim 2, wherein the emitted acoustic shock waves or pressure pulses are spherical, radial, convergent, divergent, planar, near planar, focused or unfocused from a source with or without a lens that is one of electrohydraulic, electromagnetic, piezoelectric, ballistic or water jets configured to produce an acoustic shock wave and wherein the acoustic shock waves or pressure pulses are administered invasively or noninvasively.

16. The treatment method of claim 10, wherein the number of repeated treatments occur on a schedule over a period of three or more weeks, and treatments can be repeated over time as a pain prevention protocol over longer durations of time between repeated treatments.

17. The treatment method of claim 2, wherein the neurological medical condition is one of Alzheimer's Disease, Amyotrophic Lateral Sclerosis (ALS), Ataxia, Epilepsy and Seizures, headache, Hydrocephalus, Meningitis, Parkinson's Disease, Stroke, Cluster Headaches, Tension Headaches, Migraine Headaches, Encephalitis.

18. The treatment method of claim 2, wherein the emitted acoustic shock waves or pressure pulses have an energy density in the range of 0.01 mJ/mm² to 50 mJ/mm².

19. A treatment method to reduce or eliminate a patient's symptoms caused by a neurological medical condition; the treatment comprises the step of:
administering acoustic shock waves or pressure pulses directed to an area near a source of the neurological medical condition, and to a reflexology zone to treat the neurological medical condition.

20. The treatment method of claim 19, wherein the neurological medical condition is Alzheimer's disease, and the treatment reduces neurological inflammation and plaque.
